(19) United States
(12) Patent Application Publication
(10) Pub. No.: US 2008/0306915 A1
(43) Pub. Date: Dec. 11, 2008

(54) System and Method for Data Management

(76) Inventors: Ming-Jen Wang, Hsinchu (TW); Kuen-Meau Chen, Hsinchu (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/850,759

(22) Filed: Sep. 6, 2007

(30) Foreign Application Priority Data
Jun. 7, 2007 (TW) 096120595

(51) Int. Cl. G06F 7/00; G06F 3/048

(52) U.S. Cl. 707/3; 715/764

(57) ABSTRACT

A system and method for data management is disclosed. The data management system comprises a database and a display interface. The database stores data and metadata, wherein the metadata corresponds to the data. The display interface comprises a graphical interface and a searching interface. The graphical interface is used to display the data. The searching interface is used to search the creation time, accessed time or the number of accesses of the data.

### BACKGROUND OF THE INVENTION

1. Field of the Invention

The present invention relates to a system and method for data management, and more particularly, to a system and method for data management capable of searching within a time range.

2. Description of the Related Art

The nearly overwhelming expansion of the Internet has brought about numerous numbers of web pages. Usually, when a user uses a standard browser to view webpage to save a particular webpage, the user can save the webpage in a “bookmarks” or “my favorites” data fold. However, with time, the user may forget the previous setup used. Also, in the prior art technology, the user can configure different groups to sort the “bookmarks”, but cannot know the creation time and accessed time for the “bookmarks”, or the frequency of access of the “bookmarks”. Therefore, the user needs to recall the different times of creating the “bookmarks”, which is very inconvenient.

Therefore, it is desirable to provide a system and method for data management to mitigate and/or obviate the aforementioned problems.

### SUMMARY OF THE INVENTION

A main objective of the present invention is to provide a system for data management capable of searching within a time range.

Another objective of the present invention is to provide a method for data management

In order to achieve the above mentioned objective, a data management system of the present invention comprises a database and a display interface. The database stores data and metadata, wherein the metadata corresponds to the data. The metadata may be a creation time, an accessed time, a number of accesses, names, internet addresses, keywords, visualization parameters, etc. There may be metadata for each corresponding piece of data. The display interface comprises a graphical interface and a plurality of searching interface. The graphical interface presents the data, and the plurality of searching interfaces are used for searching the data. The visualize parameter comprises a parameter of a transparency and a parameter of a color for the presentation of an icon on the graphical interface. The graphical interface displays data groups and the icons composing the data groups, and the manner of such division may be decided by the user. The plurality of searching interface comprises a first searching interface, a second searching interface, a third searching interface and a keyword searching interface. The first searching interface, the second searching interface and the third searching interface may be a searching interface having a linear axis. The first searching interface searches the range in the creation time of each item of data in the data; the second searching interface searches the range in the accessed time of each item of data in the data; and the third searching interface searches the range in the number of accesses of the data for each item of data in the data. The keyword searching interface performs searches based on pre-established keywords.

In a method for data management system of the present invention, when a user wants to save webpage data, the webpage data can be stored in the database. Furthermore, the system also simultaneously records the corresponding metadata. When the user accesses each item of data in the data, the system simultaneously changes the accessed time, the number of accesses, etc., within the metadata. The data stored in the database is displayed in the graphical interface. The user can recognize the type of data according to the data groups displayed on the graphical interface. The user can also recognize the accessing frequency according to the transparency and the color of the icon. The user can use the searching interface to perform a search to find data based on the metadata.

Other objects, advantages, and novel features of the invention will become more apparent from the following detailed description when taken in conjunction with the accompanying drawings.

### BRIEF DESCRIPTION OF THE DRAWINGS

FIG. 1 shows a data management system according to the present invention.

FIG. 2 illustrates a database according to the present invention.

FIGS. 3A-3B are schematic drawings of a graphical interface according to the present invention.

FIG. 4 is a flowchart of a method for data management according to the present invention.

FIGS. 5A-5B illustrate using a graphical interface according to the present invention.

### DETAILED DESCRIPTION OF THE PREFERRED EMBODIMENT

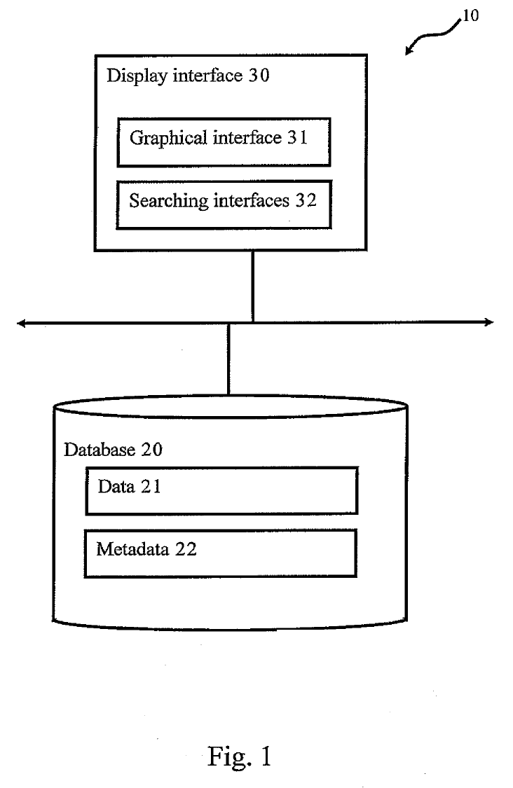

Please refer to FIG. 1. FIG. 1 shows a data management system according to the present invention.

A data management system 10 of the present invention comprises a database 20 and a display interface 30. In order to increase usability, the data management system 10 may utilize and be provided by an Extensible Markup Language (XML) interface, but other various designs can also be suitable. The database 20 stores data 21 and metadata 22, and the metadata 22 corresponds to the data 21. In this embodiment, the data 21 can comprise webpage data. The display interface 30 comprises a graphical interface 31 and a plurality of searching interfaces 32; the display interface 30 is provided for the benefit of a user. The graphical interface 31 presents the data 21, and the plurality of searching interfaces 32 are used to provide searching functionality for the user. The operation of the display interface 31 will be explained later.

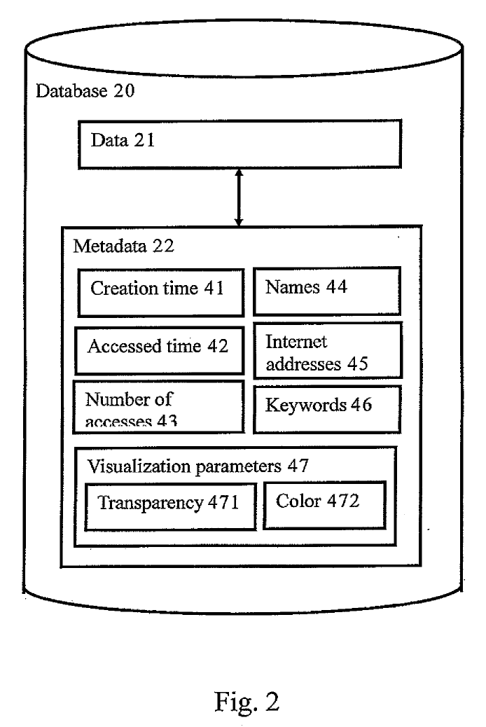

Please refer to FIG. 2. FIG. 2 depicts a database according to the present invention.

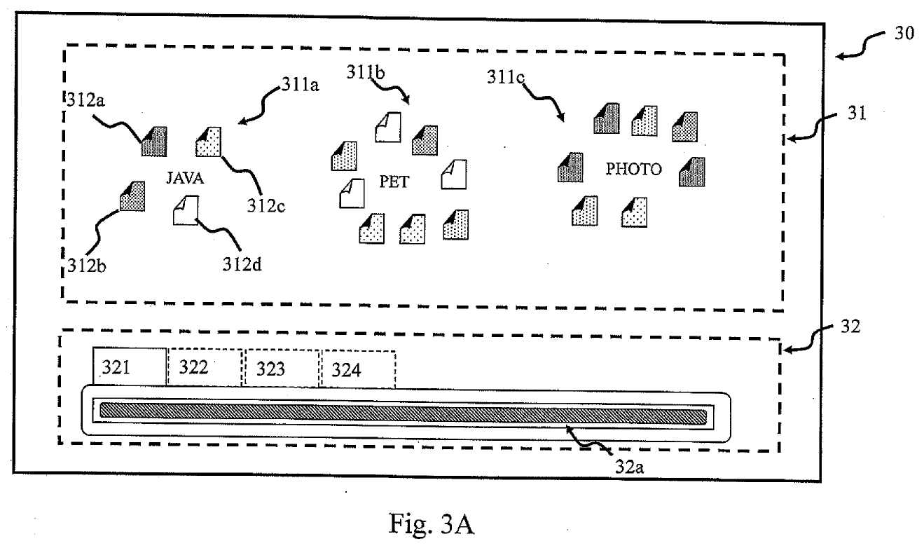

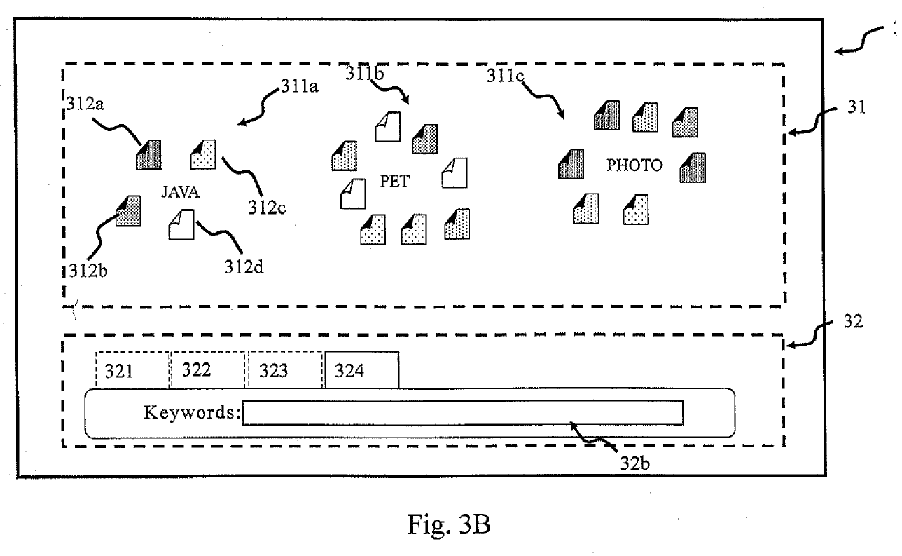

The database 20 includes the data 21 and the metadata 22. The metadata 22 corresponds to the data 21. In this embodiment, the metadata 22 may be a creation time 41, an accessed time 42, a number of accesses 43, names 44, internet addresses 45, keywords 46, visualization parameters 47, etc. There may be metadata 22 for each corresponding piece of data 21. The accessed time 42 indicates the most recent access time of each piece of data 21. The keyword 46 may relate to the name 44 and the internet address 45. In this embodiment, the visualization parameter 47 comprises a parameter of a transparency 471 and a parameter of a color 472 for the presentation of an icon (such as a first icon 312a to a fourth icon 312d shown in FIG. 3A) on the graphical interface 31. The transparency 471 and the color 472 may correspond to the accessed time 42 and the number of accesses 43. The visualization parameter 47 may have not only the parameter of the transparency 471 and the parameter of the color 472 but also a size parameter, a shape parameter or a three-dimensional spatial positioning parameter For example, the size parameter may represent the accessed time 42, while the shape parameter may represent the number of accesses 43. Or the metadata 22 may be represented by the three-dimensional spatial positioning parameter. In addition, the metadata 22 of the present invention can be of various types, and is not limited to the above description.

Please refer to FIGS. 3A-3B. FIGS. 3A-3B are schematic drawings of a graphical interface according to the present invention.

The display interface 30 comprises a graphical interface 31 and a plurality of searching interfaces 32. The graphical interface 31 displays data groups and the icons composing the data groups. The data groups 311a, 311b and 311c are divided from the data 21, and the manner of such division may be decided by the user. As shown in FIG. 3A, the data 21 is divided into a first data group 311a, a second data group 311b and a third data group 311c. The first data group 311a comprises a first icon 312a, a second icon 312b, a third icon 312c and a fourth icon 312d. Each icon presents an image for each piece of data in data 21; for example, a webpage picture for each data item in data 21. Each icon has a different transparency or color according to the accessed time or the number of accesses, i.e., based on the above-mentioned visualization parameter 47. In this embodiment, the plurality of searching interfaces 32 comprise a first searching interface 321, a second searching interface 322, a third searching interface 323 and a keyword searching interface 324. The first searching interface 321, the second searching interface 322 and the third searching interface 323 may be a searching interface having a linear axis 32a. The first searching interface 32 searches the range in the creation time 41 of each item of data in the data 21; the second searching interface 33 searches the range in the accessed time 42 of each item of data in the data 21; and the third searching interface 34 searches the range in the number of accesses 43 for each item of data in the data 21. The keyword searching interface 35 can have an input interface 32b, and the keyword searching interface 35 performs searches based on pre-established keywords 46.

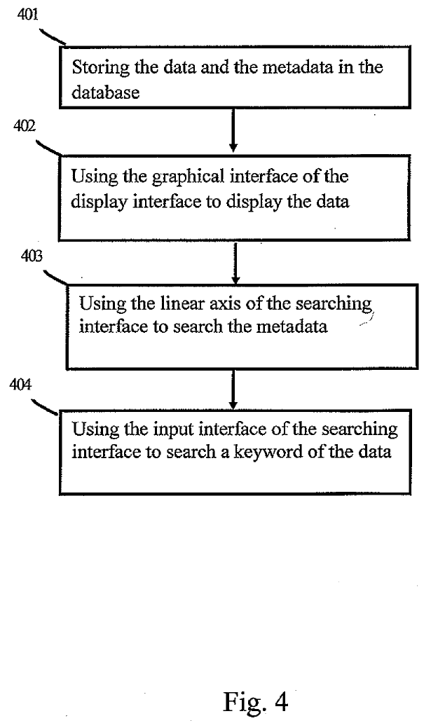

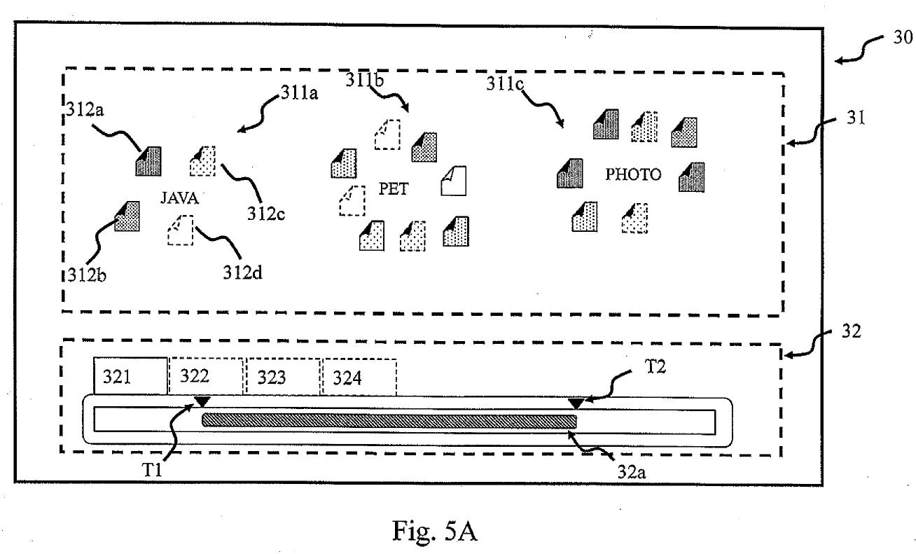

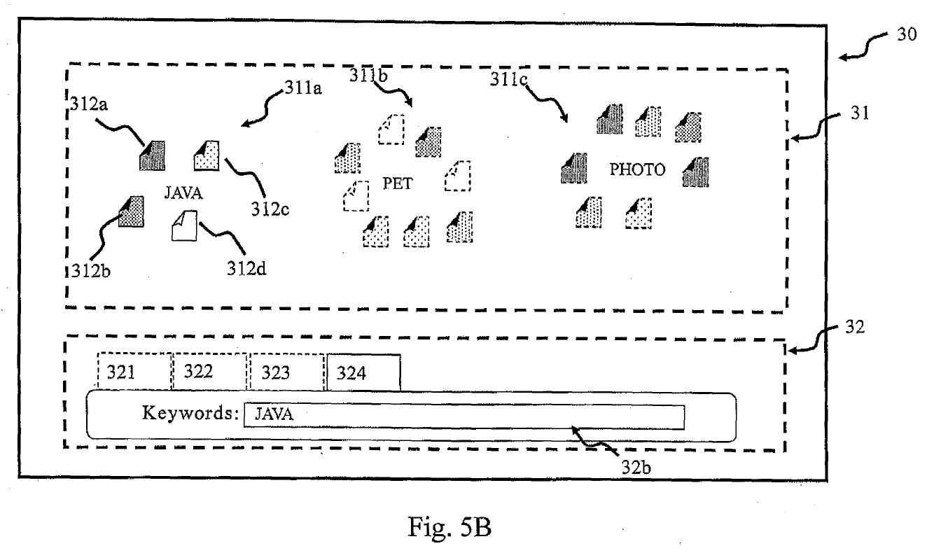

Please refer to FIG. 4 and FIGS. 5A-5B. FIG. 4 is a flowchart of a method for data management according to the present invention. FIGS. 5A-5B illustrates using a graphical interface according to the present invention.

Step 401: storing the data 21 and the metadata 22 in the database 20.

When a user wants to save webpage data, the webpage data can be stored in the database 20. Furthermore, the system also simultaneously records the corresponding metadata 22. When the user accesses each item of data in the data 21, the system simultaneously changes the accessed time 42, the number of accesses 43, etc., within the metadata 22.

Step 402: using the graphical interface 31 of the display interface 30 to display the data 21.

The data 21 stored in the database 20 is displayed in the graphical interface 31. The user can recognize the type of data according to the data groups displayed on the graphical interface 31. The user can also recognize the accessing frequency according to the transparency 471 and the color 472 of the icon.

Step 403: using the linear axis 32a of the searching interface 32 to search the metadata 22.

The user can use the searching interface 32 to perform a search to find data based on the metadata 22. For example, in this embodiment, in order to select a particular range of the creation time of the data 21, the first searching interface 321 may be selected; then, a time range on the linear axis 32a is selected. The desired data can thus be found in the data 21, as shown in FIG. 5A. The linear axis 32a in FIG. 5A has a selection range from a first time T1 to a second time T2, and the graphical interface 31 displays the first icon 312a and the second icon 312b in the first data group 311a. Subsequently, with the graphical interface 31, the user can know that the creation time of the first icon 312a and the second icon 312b is within the range of the first time T1 to the second time T2. The second searching interface 322 and the third searching interface 323 can be operated in the same manner as the first searching interface 321, and therefore there is no need for further description.

Alternatively, in step 404: using the input interface 32b of the searching interface 32 to search a keyword of the data 21.

As shown in FIG. 5B, the user can choose the keyword searching interface 324. The user can type a keyword, such as “JAVA”, in the input interface 32b, and the display interface 30 searches through the keywords 46 within the metadata 22. The first data group 311a shown in FIG. 5B is the search result. Additionally, the present invention may use more than one searching interface; the user can use all of the above-mentioned searching interfaces to cross reference for better search results.

The user can thus use the data management system 10 of the present invention to manage data based on personal experience and preferences. Although the present invention has been explained in relation to its preferred embodiment, it is to be understood that many other possible modifications and variations can be made without departing from the spirit and scope of the invention as hereinafter claimed.

What is claimed is:

1. A system for data management comprising:
a database having data and metadata, wherein the metadata corresponds to the data; and
a display interface comprising:
a graphical interface having a plurality of icons, the icons representing the corresponding data in the database; and
a searching interface for searching a particular range within the metadata.

2. The system for data management as claimed in claim 1, wherein the metadata comprises:
creation time of the data;
accessed time of the data; and
a number of accesses to the data.

3. The system for data management as claimed in claim 2, wherein the searching interface comprises a linear axis, and the linear axis is used for searching a range within the creation time, a range within the accessed time or a range within the number of accesses to the data.

4. The system for data management as claimed in claim 1, wherein the metadata further comprises:
a name of the data;
an internet address of the data; and
a keyword of the data.

5. The system for data management as claimed in claim 4, wherein the searching interface comprises an input interface that is used for searching the keyword.

6. The system for data management as claimed in claim 1, wherein the data is dividable into data groups, and the graphical interface displays the data groups.

7. The system for data management as claimed in claim 1, wherein the icon is used for displaying a visualization parameter of the data.

8. The system for data management as claimed in claim 7, wherein the visualization parameter is determined based on the number of accesses to the data and the accessed time of the data.

9. The system for data management as claimed in claim 8, wherein the visualization parameter comprises a transparency parameter, a color parameter, a size parameter, a shape parameter or a three-dimensional spatial positioning parameter of the icon.

10. The system for data management as claimed in claim 1, wherein the display interface is an Extensible Markup Language (XML) interface.

11. A method for data management in a data management system, the method comprising:
storing data and metadata in a database, wherein the metadata corresponds to the data;
providing a graphical interface of a display interface to display the data; and
providing a searching interface of the display interface to search a particular range within the metadata.

12. The method as claimed in claim 11 further comprising:
establishing a creation time of the data, an accessed time of the data, and a number of accesses to the data.

13. The method as claimed in claim 12, wherein the searching step further comprises: using a linear axis to search a range within the established time, a range within the accessed time or a range within the number of accesses of the data.

14. The method as claimed in claim 11 further comprising:
establishing a name for the data, an internet address for the data, and a keyword for the data.

15. The method as claimed in claim 14, wherein the searching step further comprises: using an input interface to search for the keyword of the data.

16. The method as claimed in claim 11 further comprising:
dividing the data into a data group.

17. The method as claimed in claim 11, wherein the step of establishing the graphical interface further comprises establishing a plurality of icons representing the data.

18. The method as claimed in claim 17 further comprising:
establishing a visualization parameter for the data, wherein the visualization parameter is determined based on the number of accesses to the data and the accessed time of the data.

19. The method as claimed in claim 18, wherein the step of establishing the visualization parameter further comprises using the visualization parameter to set a transparency, a color, a size, a shape or a three-dimensional spatial positioning parameter for the icon.
